(19) United States
(12) Patent Application Publication
(10) Pub. No.: US 2017/0103164 A1
(43) Pub. Date: Apr. 13, 2017

(54) SYSTEM AND METHOD FOR DYNAMIC AUTONOMOUS TRANSACTIONAL IDENTITY MANAGEMENT

(71) Applicant: PokitDok, Inc., San Mateo, CA (US)

(72) Inventors: Tim Dunlevy, San Mateo, CA (US); Theodore C. Tanner, Jr., San Mateo, CA (US); Denise Gosnell, San Mateo, CA (US); Thomas Dixon Whitmire, IV, San Mateo, CA (US)

(21) Appl. No.: 14/884,703

(22) Filed: Oct. 15, 2015

Related U.S. Application Data
(60) Provisional application No. 62/240,497, filed on Oct. 12, 2015.

(51) Int. Cl. G06F 19/00; G06F 17/30

(52) U.S. Cl. CPC G06F 19/322; G06F 17/30371

(57) ABSTRACT

A dynamic and autonomous identity management system and method are disclosed that provide a means of consolidating patient identity data from disparate data sources into a single system, making patient data easily accessible in a uniform and transparent manner.

### PRIORITY CLAIM/RELATED APPLICATION

This application claims the benefit under 35 USC 119(e) and priority under 35 USC 120 to U.S. Provisional Patent Application Ser. No. 62/240,497, filed on Oct. 12, 2015, and entitled “System And Method For Dynamic Autonomous Transactional Identity Management”, the entirety of which is incorporated herein by reference.

### FIELD

The disclosure relates to health care identity management.

### BACKGROUND

The United States' meaningful use policy is intended to improve the efficiency of a health care provider's practice and improve patient outcomes through the use of an Electronic Health Record (EHR) system. Ideally, an EHR system records patient data, tracks clinical processes, and provides a means of sharing data with other providers involved in a patient's care. EHR systems are certified to ensure that they meet the guidelines set forth in the American Recovery and Reinvestment Act of 2009, aka The Recovery Act. While The Recovery Act defines minimum guidelines for meaningful use acceptance, it does not provide standards on electronic data interchange (EDI) between systems. The current standard widely used for EHR EDI transmissions is HL7, which is governed by Health Level Seven International.

While EHR systems generally support HL7 as a means of generating EDI transactions, implementations vary greatly between EHR systems. As a result sharing data between systems and consolidating records throughout multiple systems is a complex effort, as EHR systems support differing and sometimes customized versions of the HL7 standard.

### BRIEF DESCRIPTION OF THE DRAWINGS

FIG. 1 illustrates an example of an embodiment of a healthcare identity management system;

FIGS. 2-3 illustrate an example of a data schema implemented for this identity management procedure;

FIG. 4 illustrates an example of a data structure of the identity management system;

FIG. 5 illustrates an example of an internal identity matching pipeline utilized in this system;

FIG. 6 illustrates an example of an identity merging architecture of the system;

FIG. 7 illustrates an example of another embodiment of a healthcare identity management system; and

FIG. 8 illustrates an example of an implementation of the identity management system.

### DETAILED DESCRIPTION OF ONE OR MORE EMBODIMENTS

The disclosure is particularly applicable to an identity management system for healthcare as described below and it is in this context that the disclosure will be described. It will be appreciated, however, that the system and method has greater utility, such as to managing identities for other system that those below or be implemented in other manners than those described below. In the embodiment described below, the identity management system may be a PokitDok Identity Management system. As another example, the identity management system may be a standalone component/system or may be part of a healthcare system such as the PokitDok healthcare system in one embodiment.

The dynamic and autonomous identity management system described below provides a means of consolidating patient identity data from disparate data sources into a single system, making patient data easily accessible in a uniform and transparent manner.

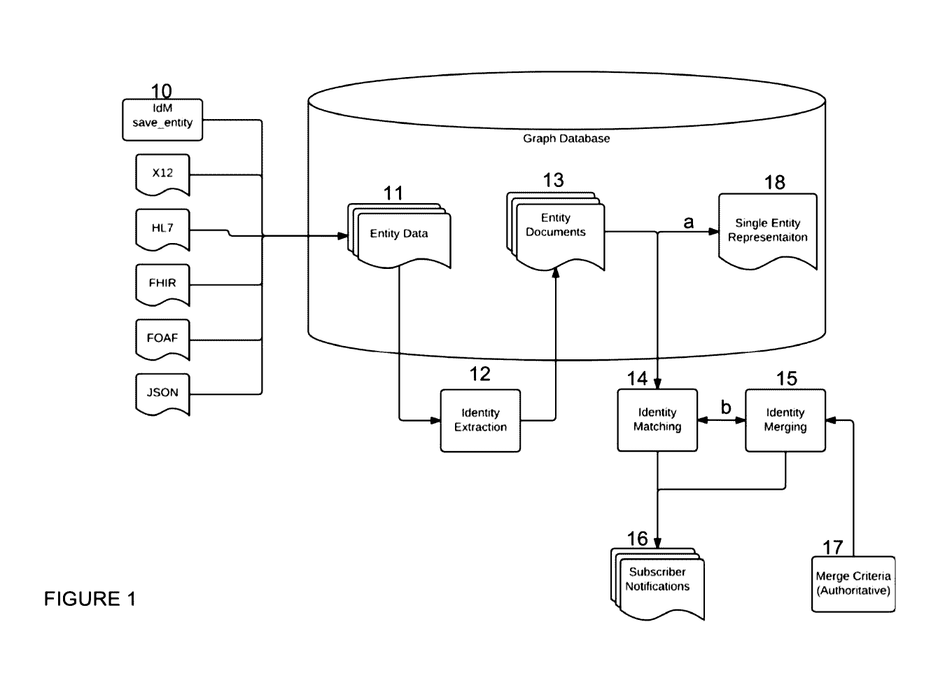

FIG. 1 illustrates an architecture and solution to identity management. Herein, the system transforms a streaming transactional data architecture into an identity management solution. Element 1.10 illustrates the save_entity transaction as an aggregate transaction supporting multiple data interchange standards including, but not limited to: ASCII ANSI X12, HL7, FHIR, FOAF, and JSON. These formats are streamed as inputs and persisted separately within the graph database specified as element 1.11.

Algorithm 1 illustrates the save_entity implementation used to persist entity data within the graph.

Algorithm 1

```
def save_entity(self, data_sets):
  for data_set in data_sets:
    data_adapter = self.load_adapter(data_set)
    data_adapter.submit(data_set)
```

The implementation accepts one or more data sets as input, as specified by the data_sets parameter. The system matches a data adapter to each data set received and then persists the data set within the system. Data adapters encapsulate the operations required to work with each unique data set format such as JSON, ASCII ANSI X12, HL7, FHIR, FOAF, and JSON. Finally the data adapter submits each data set to the system in a non-blocking fashion as seen in FIG. 1, element 11.

This solution extracts, persists, resolves and updates a unified identity for the entity observed throughout our stream of transactions. Element 1.13 may persist a conceptual property model of each entity in the graph with appropriate data provenance identifiers. The processes at elements 1.14, 1.15, 1.16, 1.17, and 1.18 create the dynamic autonomous pipeline of this identity management system. The data at 1.13 is lassoed and duplicates are identified via an autonomous identity matcher at 1.14. The matching criteria at 1.14 can be both learned thresholds (dynamic) and subscriber specific (static defined rules) regulations. This built in flexibility is necessary for protecting patient identity, the most critical piece of this system. With a set of identified duplicates, the data is checked for known subscriber regulations at 1.16, such as those outlined in the Health Insurance Portability and Accountability Act Privacy Rule or stricter payor specific regulations. At element 1.15, the system merges the identities and create identity profiles which adhere to the entity's regulations which are controlled at element 1.17. As transitions are continuously streamed into the architecture, the merged identities are stored in the graph database at 1.18 and are updated dynamically according to the optimization functions at 1.14.a and 1.14.b.

Service Views

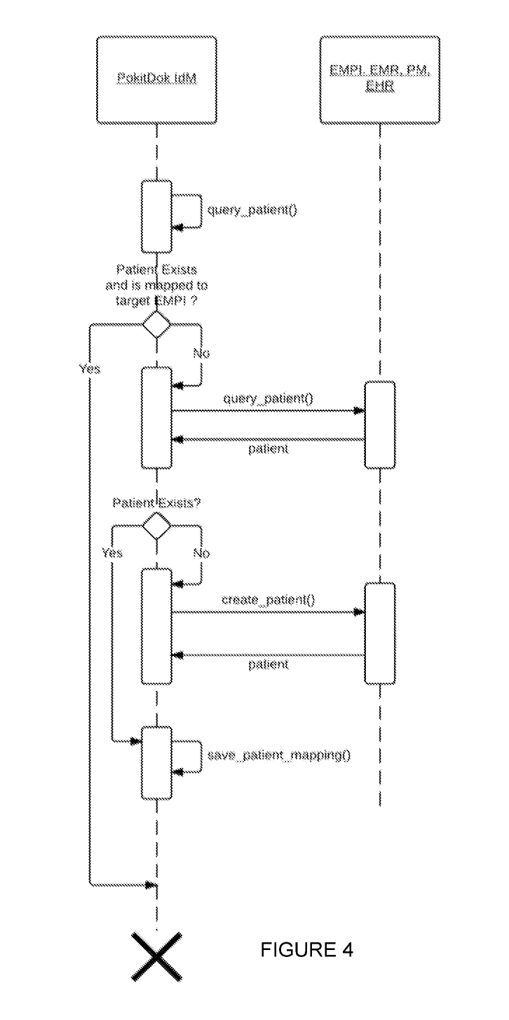

FIG. 4 demonstrates the interaction of the Identity Management Solution with an external health care enterprise system such as an Enterprise Master Person Index (EMPI), Electronic Medical Record (EMR), Practice Management (PM), or Electronic Health Record (EHR) system. For a patient in the Identity Management database (element 1.13 in FIG. 1), the system checks to see if the system has created the mapping for this identity to the respective external system. If the patient is not mapped in the system, the system queries the external interface with the patient's strong identifiers. If this patient does not exist, the system creates the patient in the external system, establish the patient mappings and use these transactions to update our internal transactional stream as described in FIG. 1.

The identity record data structure may be:

```
{
  “first_name”: “John”,
  “middle_name”: “P”,
  “last_name”: “Doe”
  “birth_date”: “1980-02-17”,
  “gender”: “M”,
  “external_ids”: {“external_system_a”: “WQ123456789”,
```

“external_system_b”: “P-1432”}

}

The identity record data structure contains demographic data and is used as an input to query_patient and save_patient_mapping functions throughout the system. The external_ids field is a map structure, used to maintain an external system identity ids. A map entry is indexed on the external system id and resolves to the external system id value.

Algorithm 2 query_patient( ) implementation:

```
query_patient(self, pd_identity_record, external_system_id):
  pd_identity_record = self.identity_service.find(pd_identity_record)
if not pd_identity_record:
  pd_identity_record = self.identity_service.create(pd_identity_record)
system_adapter = self.load_system_adapter(external_system_id)
external_patient = system_adapter find(pd_identity_record)
if not external_patient:
  external_patient = system_adapter.create(pd_identity_record)
return external_patient
```

The query_patient function has two arguments the pd_identity_record (FIG. 4) and the external_system_id. The external_system_id is a system defined unique identifier used to identify each external systems that are supported within the Identity Management Solution. The external_system_id is used to load the appropriate system_adapter for the external system. Each system adapter is used to encapsulate search operations for the external system.

Algorithm 3 save_patient_mapping( ) implementation:

```
save_patient_mapping(self, pd_identity_record, external_patient):
  if external_patient.system_id not in pd_identity_record.external_ids:
    pd_identity_record.external_ids[external_patient.system_id] =
    external_patient.id
```

The save_patient_mapping function updates an Identity Management Solution identity_record (FIG. 4) with the external system to external system patient id mapping.

Database Schema

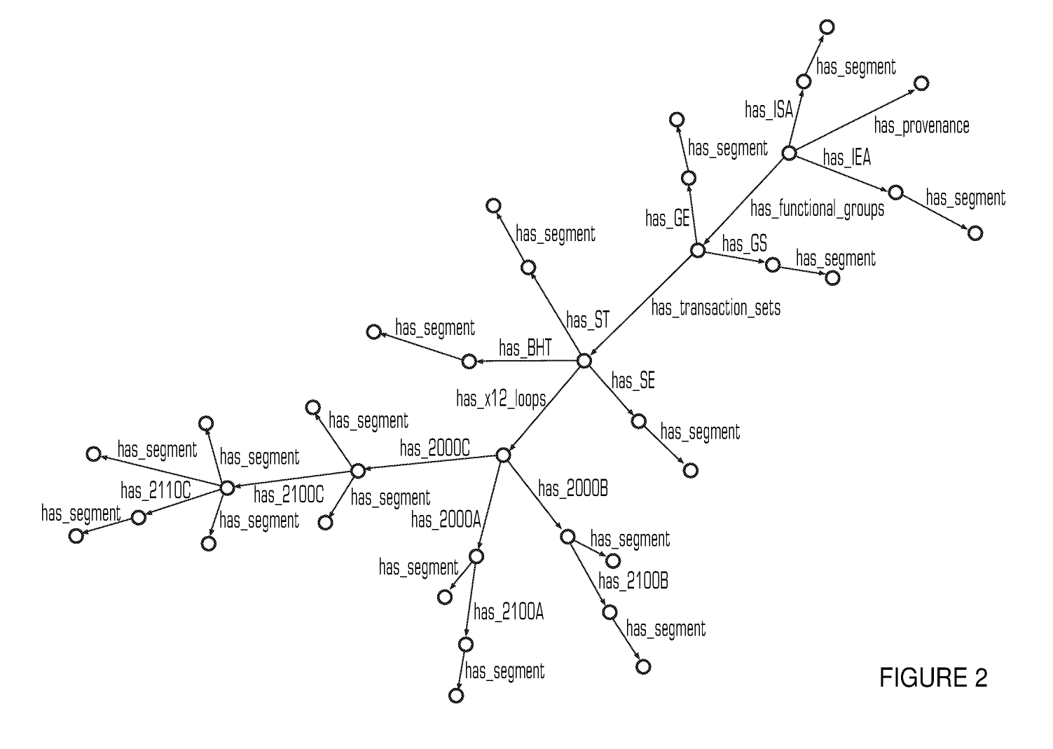

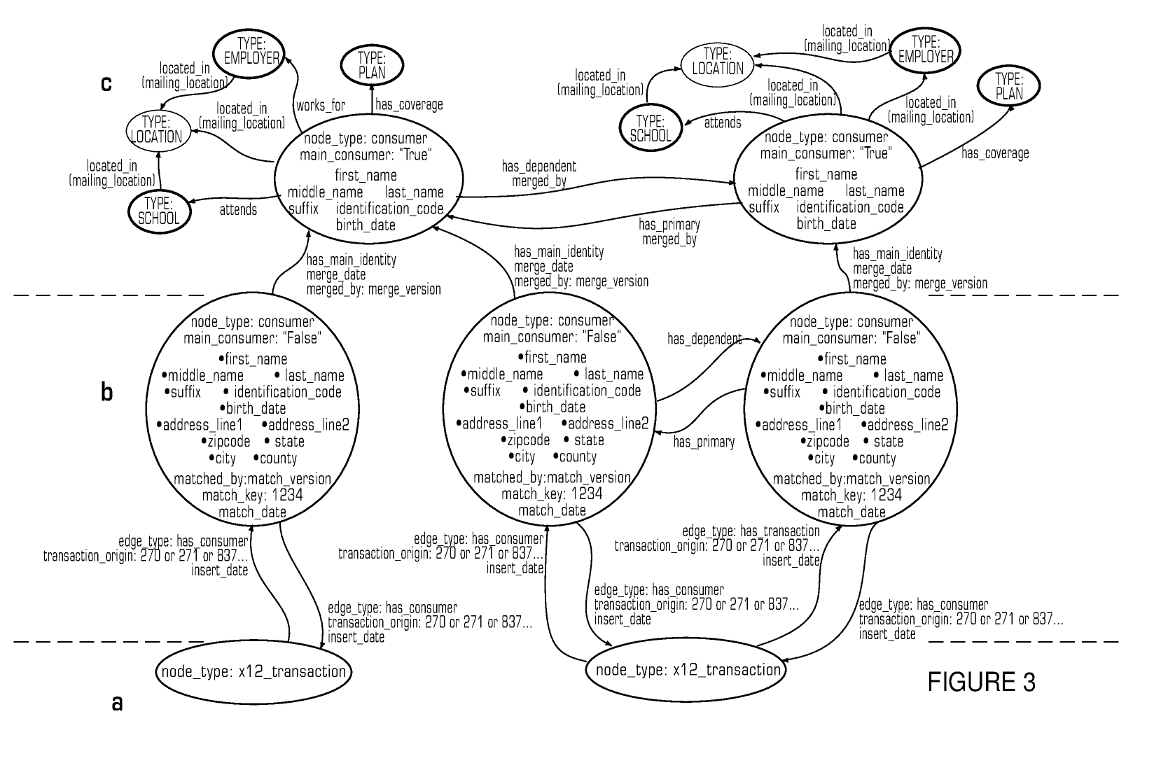

The identity extraction process (element 1.12) relates multiple entity documents (FIG. 1, element 1.11) to a consolidated document (FIG. 1, element 1.18) using the matching (FIG. 1, element 1.14) and optional merging (FIG. 1, element 1.15) processes. Together, FIG. 2 and FIG. 3 provide a specific example of the schema implemented for this procedure.

Specifically, FIG. 2 shows the immutable transactional property graph model for an eligibility request for an office visit. FIG. 3 depicts the three stages of the identity persistence for a consumer. FIG. 3.a corresponds to the root of this transaction from FIG. 2; this is an immutable data structure in the graph database. Next, at FIG. 3.b, the system extracts a bag of words consumer model from every transaction, which streams through the PokitDok EDI architecture. The bag-of-words model at FIG. 3.b extracts and persists human readable key value pairs from the EDI transaction as one vertex in the graph architecture. Lastly, the system creates a merged property graph model at FIG. 3.c that serves as the main identity for the consumer of interest. In its entirety, FIG. 3 shows the persistence of the entity extraction from the transaction through the resulting merged property graph model for the duplicate consumers in the example. Persistence stages 3.a, 3.b, and 3.c in FIG. 3 correlate to the architecture stages 1.11, 1.13, and 1.18, respectively, from FIG. 1.

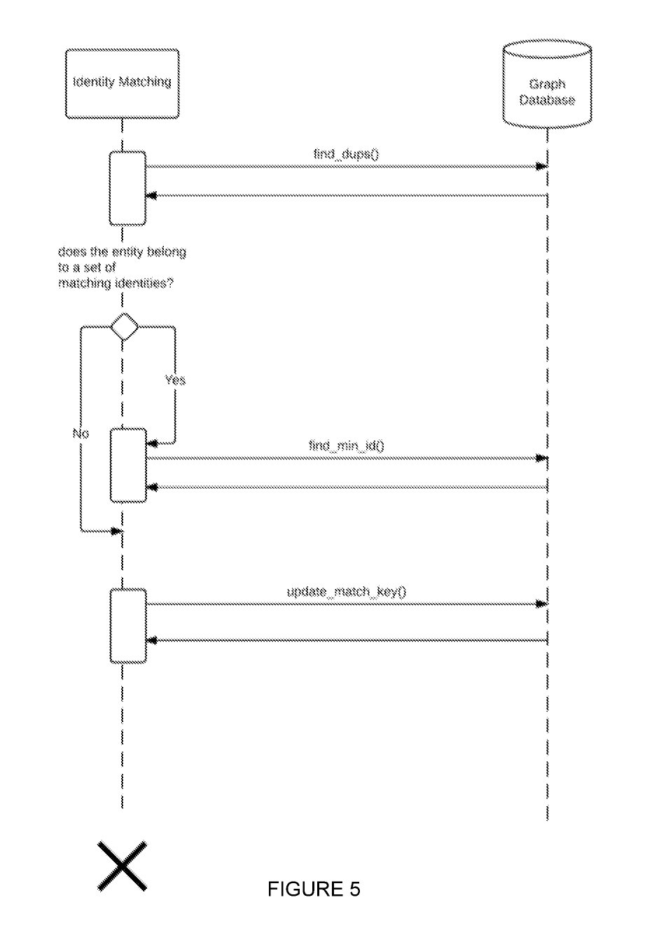

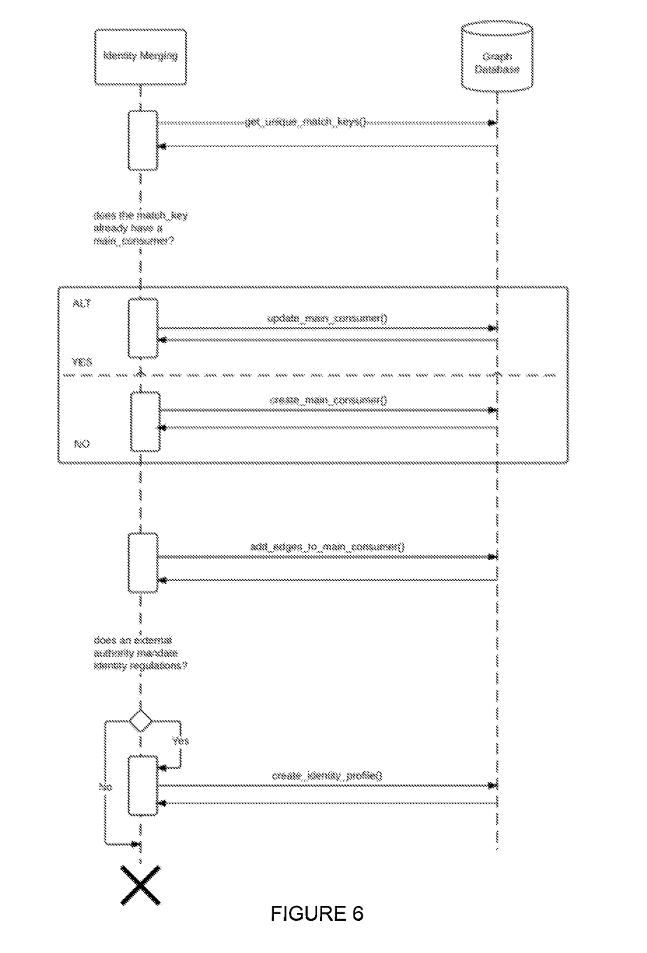

FIG. 5 outlines the internal identity matching pipeline utilized in this system. The pipeline dynamically queries the models available at 1.13 and 1.18 in FIG. 1 and identifies sets of duplicate entities. Each set of duplicate entities receives a unique match key to be exploited in the identity merging pipeline. FIG. 6 details the identity merging architecture. For each unique match key observed at 1.13 and 1.18 in FIG. 1, the identity merging pipeline either creates or updates the merged representation for that identity, as shown in FIG. 5.

FIG. 6. To provide external control to regulate identities in the system, the identity merging pipeline creates a profiled representation for each entity which requires additional management. The regulations can create profiled representations within the identity management system via learned autonomous threshold or manual data extractions.

Formal Definition of Entity Evolution

There are entire fields of theoretical research on matching, entity resolution, fuzzy grouping, and object consolidation. All of these approaches are referring to the same underlying generic problem: a dataset D contains m entries:

D={d₁, d₂, . . . dₘ}. The entries can be different types with varying relationships to other entities. The objective of a solution in entity resolution is to define a set R={r₁, r₂, . . . rₙ} such that |R|=n<=m=|D| and every element in D correctly maps to an element in R. That is, R is the set of instantiated attributes of the objects in D. Extensive reviews of previous methods and solutions in this space can be found in, but not limited to, the following: 1) Chen, Zhaoqi, Dmitri V. Kalashnikov, and Sharad Mehrotra. “Adaptive graphical approach to entity resolution.” Proceedings of the 7th ACM/IEEE-CS joint conference on Digital libraries. ACM, 2007; 2) Christen, Peter. Data matching: concepts and techniques for record linkage, entity resolution, and duplicate detection. Springer Science & Business Media, 2012; and 3) Cohen, William, Pradeep Ravikumar, and Stephen Fienberg. “A comparison of string metrics for matching names and records.” Kdd workshop on data cleaning and object consolidation. Vol. 3. 2003. The system combines domain specific features with proven techniques in similarity scoring and novel approaches in graph isomorphisms to adapt feature thresholds 6′ to dynamically create R from a continuous stream of healthcare transactions.

Recall the architecture outlined at 1.13 and 1.18 from FIG. 1. Given the definition above, FIG. 1.13 will now be referred to as set R whereas FIG. 1.18 corresponds to set D. The system utilizes both the features and relationships from our architecture to learn, train, and update the matching algorithm at FIG. 1 element 1.14. The system may combine similarity techniques from the bag of words model demonstrated at FIG. 3.b, inferred relationships at 3.c, feature similarity scoring, and domain knowledge to create the backbone of the identity matching algorithm. The system may also apply optimization techniques, such as linear programming, to dynamically create an evolved representation of an entity's identity by minimizing the difference in similarity across the identity's evolution.

Algorithm 4 calculate_similiarty_score( ) implementation:

```
calculate_similarity_score(self, pd_identity_record_a,
pd_identity_record_b):
  similarity_score = new ScoreIdentities( )
  similarity_score.score_domain_features
  (pd_identity_record_a, pd_identity_record_b)
        similarity_score.score_semantic_features
    (pd_identity_record_a, pd_identity_record_b)
        similarity_score.score_relationshp_inferences
    (pd_identity_record_a, pd_identity_record_b)
  similarity_score. score_features(pd_identity_record_a,
  pd_identity_record_b)
  similarity_score.calculate_priority_score( )
  return similarity_score.total_score
```

For example, Equation 1 below details the calculation of a graph connectivity score by calculating the total connection strength of shortest paths between two identity feature graphs:

$$graphConnectivityScore ( a , b ) = {\sum }_{p ∈ {P}_{L} ( a , b )} w ( p ) \qquad Equation 1$$

where the set L denotes the set of short paths between entity relationship graphs for identity a and identity b, p ∈L is a path in L, and w(p) denotes the total weight (or strength) of this path. To account for outliers in this distribution, the system normalizes the overall relationship inference score for two entities. In addition to applying optimization techniques to an identity's dynamically evolving graphConnectivityScore, the system utilizes a myriad of similarity algorithms such as, but not limited to, the following: cosine similarity, jaccard similarity, hamming distance, simple matching coefficients, graph isomorphisms, overlap coefficient, maximal matchings, Tversky index, Levenshtein distance, object frequency, Hellinger distance, skew divergence, confusion probability, Kullback-Leibler divergence metric, . . . etc.

Merging will be handled from highest to lowest priority merges, given that the similarity score for each merge exceeds the matching threshold δᵢ. After computing a combined similarity score with semantic similarity, relationship inference, feature similarity, and/or domain knowledge, the system merges a set of identities with the highest score, provided the overall score exceeds our matching threshold. In the case that the merge percolates a scoring change to another set of nodes, the scores will be updated and re-evaluated for merging.

The similarity scores for any two entities represent a co-reference distribution in which the system can positionally order the similarity of any two entities in relation to the global distribution. This ordering drives the supervised learning algorithm for identity management evolution. The system aims to merge identities using the similarity ordering such that the system minimizes the similarity difference function for the new mapping φ(n):D→R where:

∇r in R:φᵣ(n)−φᵣ(n−1)≧∈,∈≧0

and

φᵣ(n)=simScore(r,merger(r,c)),

where a, b∈r∉r and

simScore(a,b)>δᵢ and

simScore(a,c)>δⱼ

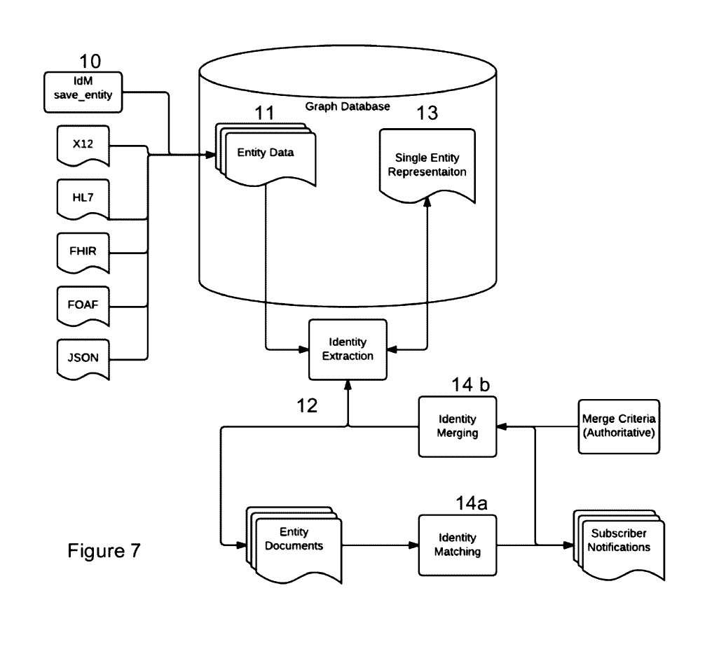

That is to say, as the system evolves the mapping and state space observed in the entity evolution set R, the system seeks to augment the set such that we minimize the similarity difference from one step to another. The application of this objective function is shown in FIG. 1 at 1.14a and 1.14b in FIG. 7 in which those processes are coupled differently to the graph database and identity extraction as shown.

For example, consider the following two identities extracted from EDI transactions:

```
  a = {
    “first_name”: “John”,
    “middle_name”: “P”,
    “last_name”: “Doe”
    “birth_date”: “1980-02-17”,
    “gender”: “M”,
    “external_ids”: {“external_system_a”: “WQ123456789”,
“external_system_b”: “P-1432”}
  }
  b = {
    “first_name”: “John”,
    “last_name”: “Doe”
    “birth_date”: “1980-02-17”,
    “gender”: “M”,
    “address”: “1 Main Street Los Angeles, CA 55555”,
    “external_ids”: {“external_system_a”: “WQ123456789”,
“external_system_b”: “P-1432”}
  }
```

These two identities would surpass the domain knowledge similarity scoring function due to matching strong identifiers from an external system. If the domain similarity scoring function has a normalized range from [0,1], then for these two documents:

domainSimScore(a,b)=1>δ_{domain}

The system would initialize D={a,b} and

R={a′}: φ(n):D→R=a,b→a′ and:

```
  a′ = {
    “first_name”: “John”,
    “middle_name”: “P”,
    “last_name”: “Doe”
    “birth_date”: “1980-02-17”,
    “gender”: “M”,
    “address”: “1 Main Street Los Angeles, CA 55555”,
    “external_ids”: {“external_system_a”: “WQ123456789”,
“external_system_b”: “P-1432”}
  }
```

Next, consider the following two identities which we would observe via separate EDI transactions:

```
  c = {
    “first_name”: “Jane”,
    “middle_name”: “P”,
    “last_name”: “Doe”
    “birth_date”: “1980-02-17”,
    “gender”: “F”,
    “address”: “1 Main Street Los Angeles, CA 55555”,
    “external_ids”: {“external_system_a”: “AB123456789”,
“external_system_b”: “P-ABCD”}
  }
  d = {
    “first_name”: “J”,
    “middle_name”: “P”,
    “last_name”: “Doe”
    “birth_date”: “1980-02-17”,
    “gender”: “M”,
    “address”: “1 Main St. LA, CA 55555”,
    “external_ids”: {“external_system_a”: “WQ123456789”,
“external_system_b”: “P-1432”}
```

The system would initialize D={a,b,c,d}. The system seeks to define a mapping φ(n+1): D→R such that every element in D maps to an element in R. First, let us consider

semanticSimScore(a′,c)>δ_{semantic}

due to the semantic similarities between the fields of the two documents. However,

domainSimScore(a′,c)<δ_{domain}

because the external system identity keys do not match. As such, the system will not augment a′ to include identity C and the system will make an isolate identity c′∈R and define φ(n+1):c→R

Lastly, the system must consider identity d. The system calculates

SemanticSimScore(a′,d)>δ_{semantic}

domainSimScore(a′,d)>δ_{domain}

The system ensures an objective function is satisfied by observing that:

φ_{a′}(n+1)=simScore(a′,merge(a′,d)) and

φ_{a′}(n+1)−φ_{a′}(n)≧∈,∈≧0

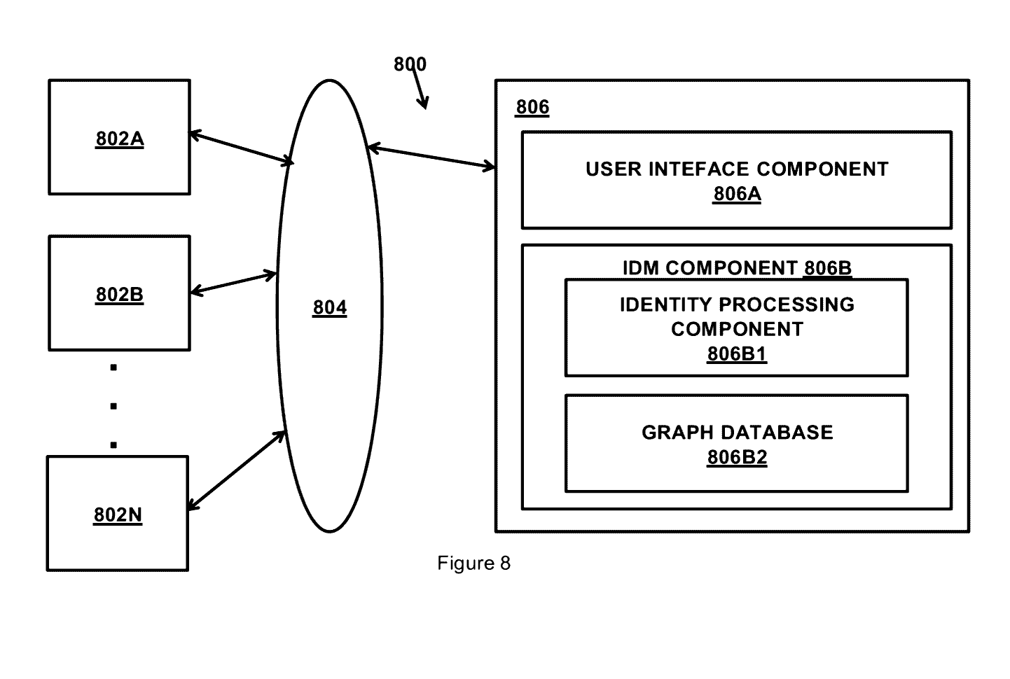

FIG. 8 illustrates an example of an implementation of the identity management system 800 that has one or more computing devices 802, such as 802A, 802B, . . . , 802N as shown in FIG. 8) which allow a user (patient, healthcare provider or any other entity with sufficient access to the system) to couple to and interact over a communications path 804 with an identity management backend system 806 in the manners described above. Each computing device 802 may be a processor based device with a display, memory, storage and connectivity capabilities. For example, each computing device may be a smartphone device, such an Apple iPhone or Android operating system based device, a personal computer, a laptop computer, a tablet computer, a terminal and the like. Each computing device 802 may have an application to facilitate connection to and communication with the identity management backend 806 such as a browser application, mobile application or any other application. Each computing device allows the user to issue a request to the identity management backend 806 and receive a response back.

The communications path 804 may be a wired or wireless network for a combination therefore that permit each computing device to connect to and interact with the identity management backend 806. For example, the communications path 804 may be one or more of Ethernet, the Internet, a wireless data network, a cellular digital data network, a computer network and the like. The communications path 804 may use various communications and data transfer protocols for its operation, such as HTTP, REST, HTTPS,TCP/IP and the like.

The identity management backend 806 may be one or more specially designed computing resoures including one or more processors, memory, storage, a communications circuit and the like. For example, the identity management backend 806 may be implemented using one or more server computers, a database server, an application server, a blade server and/or cloud computing components. Each component of the identity management backend 806 may be implemented in hardware or software. In a software implementation, each of the components is a plurality of lines of computer code executed by a processor of a computer system or of the computing resources to implement the functions of the system as described above. In the hardware implemnentation, each of the components may be a hardware device such as a a microcontroller, a programmable logic device, a field programmable gate array and the like.

The identity management backend 806 may further comprise a user interface component 806A that manages the connections and communications with each computing device. In a client server type implementation, the user interface component may be a web server. The identity management backend 806 may further comprise an identity management component 806B that performs the identity management operations and processes described above. The identity management component 806B may further comprise an identity processing component 806B1 and a graph database component 806B2 as described above. The identity processing component 806B 1 provides an interface to the graph database and may perform the identity extraction 12, identity matching 14 and identity merger 15 shown in FIG. 1.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. An identity management system, comprising:
a computer system
a data store associated with the computer system, the data store containing a plurality of patient records, wherein each patient record contains information about a particular patient;
an identity management component hosted on the computer system;
the identity management component configured to perform an identity extraction on a piece of input data to determine if the identity of the patient is contained in the data store, an identity matching on a plurality of pieces of input data about the patient to determine if the plurality of pieces of data describe the patient contained in the data store and an identity merging for autonomous evolution of the pieces of data and merging, in the graph database, the plurality of pieces of data that describe the patient contained in the data store.

2. The system of claim 1, wherein the identity extraction extracts a bag of words consumer model from every transaction for each patient.

3. The system of claim 1, wherein the identity matching generates a unique match key for each duplicate data for the patient.

4. The system of claim 1, wherein the identity merging generate a similarity score for each two pieces of data about the patient.

5. The system of claim 4, wherein the identity merging merges the pieces of data for the patient when the similar score exceeds a matching threshold.

6. The system of claim 4, wherein the identity merging first merges the pieces of data for the patient with a highest score.

7. The system of claim 1, wherein the data store further comprises a graph database.

8. An identity management method, comprising:
providing a computer system and a data store associated with the computer system, the data store containing a plurality of patient records, wherein each patient record contains information about a particular patient;
performing, based on the data store, an identity extraction on a piece of input data to determine if the identity of the patient is contained in the data store;
determining, if the plurality of pieces of data describe the patient contained in the data store;
autonomous evoluting of the pieces of data; and
merging, in the data store, the plurality of pieces of data that describe the patient contained in the data store.

9. The method of claim 8, wherein performing the identity extraction further comprises extracting a bag of words consumer model from every transaction for each patient.

10. The method of claim 8, wherein performing the identity matching further comprises generating a unique match key for each duplicate data for the patient.

11. The method of claim 8, wherein identity merging further comprises generating a similarity score for each two pieces of data about the patient.

12. The method of claim 11 wherein identity further comprising merging the pieces of data for the patient when the similar score exceeds a matching threshold.

13. The method of claim 11, wherein the identity merging further comprises first merging the pieces of data for the patient with a highest score.

14. The method of claim 8, wherein the data store further comprises a graph database.
